(19) United States
(12) Patent Application Publication
(10) Pub. No.: US 2010/0049586 A1
(43) Pub. Date: Feb. 25, 2010

(54) METHOD FOR DETERMINING AN ADVERTISING SLATE BASED ON AN EXPECTED UTILITY

(75) Inventor: Ben SHAHSHAHANI, Menlo Park, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 12/196,245

(22) Filed: Aug. 21, 2008

(51) Int. Cl. G06Q 10/00

(52) U.S. Cl. 705/10; 705/7

(57) ABSTRACT

A method of determining which of a plurality of ad slates to present on a web page uses an expected utility function, wherein the expected utility function takes into account known and unknown variables and utility functions associated with each combination of unknown variables, to calculate an expected utility for each slate, and presents the slate with the highest expected utility.

### BACKGROUND

1. Field of the Invention

Aspects of the present invention relate generally to a method for determining the best ads to present, and their positions, based on the maximization of an expected utility function.

2. Description of Related Art

Search engines (e.g., Yahoo! Search) generally show advertisements together with the results of searches, and such advertisements can be shown both inline with the results and in various other positions on the search results page (e.g., above the results, to the right of the results, etc.). Generally, when a user clicks on an ad, the advertiser pays some amount of money to the search company for the click.

Conventionally, the decision as to which ads to show is based on some metric, a score, which is generally correlated with the clickability of the ad (i.e., the probability that the user will actually click on the ad). In Internet search advertising, there are usually a limited number of ads to be displayed at any one time, in any of a number of limited positions. Display constraints can affect clickability and other metrics.

It would be desirable to predict the best ads and their corresponding presentation based on an expected utility function that can balance various factors, including, for example, revenue, cost, etc.

### SUMMARY

In light of the foregoing, it is a general object of the present invention to provide search engines with the highest value ads and related presentation, based on the maximization of an expected value of a utility function.

### BRIEF DESCRIPTION OF THE DRAWING FIGURES

FIG. 1 is a simplified block diagram illustrating how the invention may be employed.

FIGS. 2A-2B illustrate generally example layouts of ads on a search results page.

FIG. 3 is a logical flowchart of the general process by which a particular slate to be presented may be chosen.

### DETAILED DESCRIPTION

Detailed descriptions of one or more embodiments of the invention follow, examples of which may be graphically illustrated in the drawings. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of generating the most effective set of available ads in response to a search query, including their position on the page and their relative ordering.

Throughout this disclosure, reference is made to “system,” which is used to denote an advertising/search infrastructure through which an Internet advertising network operates (e.g., Yahoo's® Publisher Network, etc.). There are currently numerous advertising infrastructures (e.g., those run by Yahoo!®, Google™, etc.) and most offer similar services, such as, for example, the serving or presenting of advertisements; “serving” or “presenting,” as used herein, is the mechanism by which advertisements are delivered to web pages. Generally, the advertising infrastructure includes or is linked to a search engine, which displays search results together with possibly relevant advertisements bought against the search.

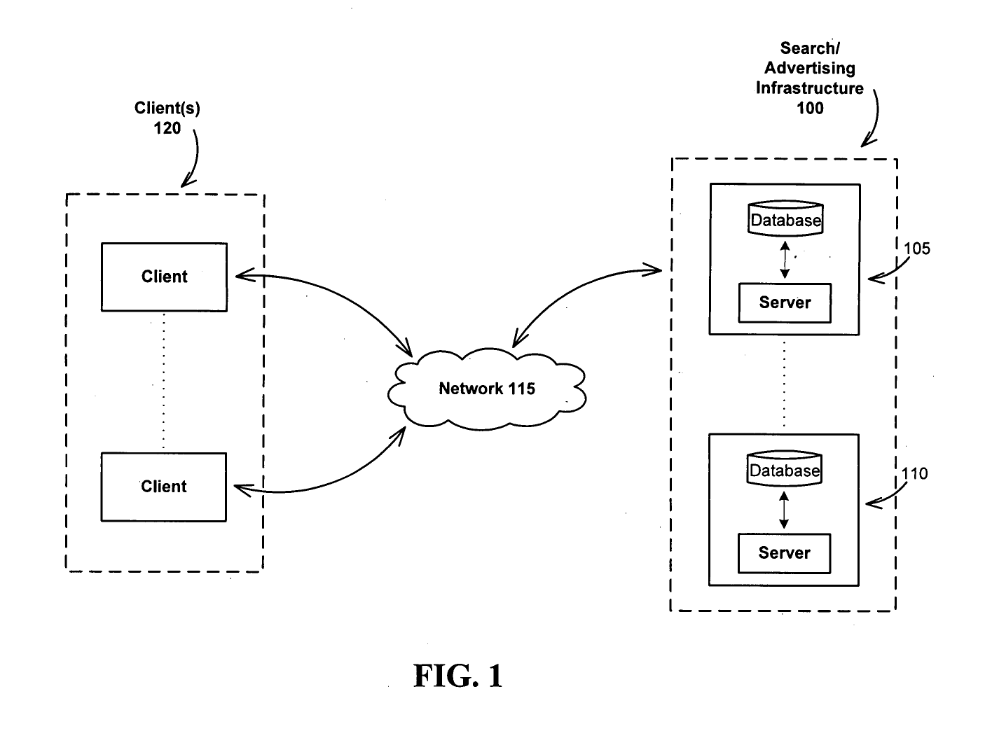

FIG. 1 is a simplified block diagram illustrating how the invention may be employed in accordance with the detailed description. Advertising/search infrastructure 100 may be a search/advertising network (e.g., as described above) and may include any of a number of servers 105 and 110 (which optionally may include databases), etc. required for its operation; advertising/search infrastructure 100 also may power the methods used to generate search results from user queries and to populate those search results, or general web pages, with ads, as described herein. Client(s) 120 may comprise a user at a computer requesting a search be done by advertising/search infrastructure 100, or requesting a general web page which may use advertising/search infrastructure 100 to display ads on the requested web page. Advertising/search infrastructure 100 and Client(s) 120 are linked together through Network 115 (e.g., the Internet, etc.).

Throughout this description, reference is made to a “query,” which is used to denote a search query given by a user when performing a search through a search engine. A query can comprise terms (or keywords), and may contain a single term, multiple terms, a phrase of terms, etc.

Throughout this description, reference also is made to a “slate,” which is used to denote a particular ad, or set of ads, in a particular position, or positions on a web page, and may also include the relative ordering of those ads. It may be the case that a slate can contain no ads (i.e., the “null” slate). The number of possible slates for any given web page (for example, a search results page) is a function of at least the number of ads available to potentially be displayed on the particular page (according to, for example, relevancy of the ad to the search query, etc.), and the number of positions available at which to show the ads, though it will be appreciated that various other constraints also may inform the possible number of slates.

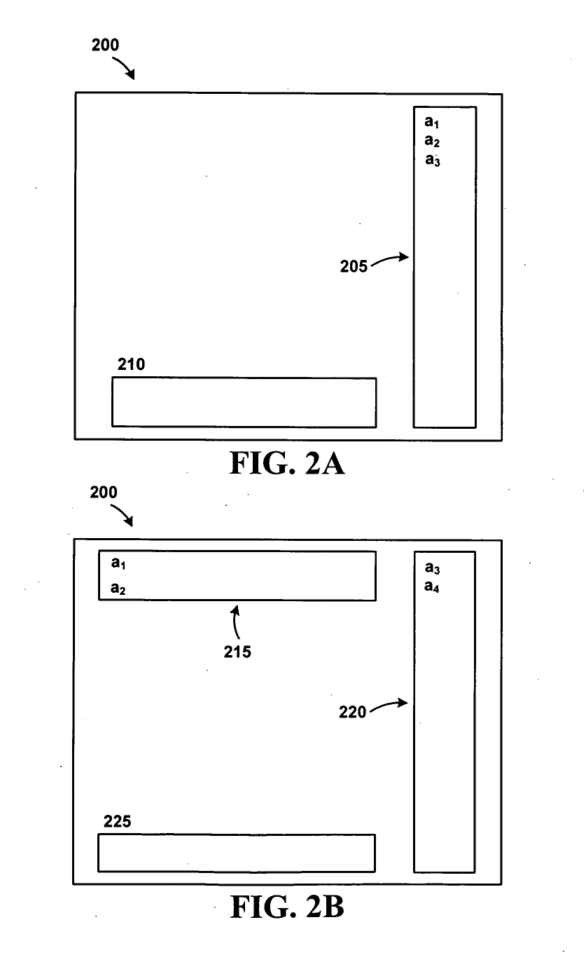

FIGS. 2A and 2B illustrate generally two example slates. FIG. 2A shows search results page 200 together with ad block 205 to the right of the page's contents. Within ad block 200 are ads a₁, a₂, and a₃, and in that particular order from top to bottom. If the position of ad block 205 remained the same, but the order of the ads within ad block 205 were switched around, then that would be considered a different slate. Similarly, FIG. 2B shows another slate, where ad block 215 contains ads a₁ and a₂ (in that order from top to bottom); ad block 220 contains ads a₃ and a₄ (in that order from top to bottom).

Assuming, with regard to the example slates illustrated in FIGS. 2A-2B, that the only positions the ad blocks could occupy are as shown (i.e., either to the right of the content or above it), then the slate may be described by a simple equation, for example, slate=(Pres_{N0,3}; a₁, a₂, a₃) for FIG. 2A, and slate=(Pres_{N2,4}; a₁, a₂, a₃, a₄) for FIG. 2B. In the above equations, Pres stands for presentation, and Pres_{Xy,z} specifies the position X of the ad block containing the first y ads (i.e., to the right of the content, above the content, etc.), and the total number of ads z; because, in this example, there are only two positions defined by Pres, the number of ads beyond the first y ads obviously must be presented in the other available ad block position. The nomenclature is simply a succinct way of summarizing a particular slate given the examples' particular constraints (e.g., only two ad block positions are available, etc.), and it will be appreciated that such nomenclature may vary widely.

Referring again to FIGS. 2A-2B, some possible configuration questions that might arise given the constraints of the example are: How many total ads should be displayed? Should all of the ads be shown together to the right of the content? Is it better to show two ads above the content, but only one ad to the right of the content? Other configuration questions are possible. Given that there are a finite number of ad block positions (two in the working examples)—each ad block is capable of containing a limited, but possibly varying number of ads—and a finite number of available ads to be shown together with a particular search, every possible slate can be deduced; by ascribing a value, or “score” to each slate, the “best” slate can then be chosen.

To determine a score for each possible slate, an expected utility function may be defined, wherein the expected utility function calculates an expected utility of each slate. The system may then choose the slate that maximizes the expected utility function. Though the expected utility function may use any applicable and available variables, it will generally at least attempt to balance the expected revenue against the “cost” of showing ads to the user. The cost generally represents the impact of a particular slate on the users, and may be informed by various and multiple factors. For example, if ad block 205 in FIG. 1A takes up half of the viewable screen, the user may be annoyed by the amount of screen real estate consumed by the ad block. Such annoyance may be associated with a high cost. As another example, it may be considered more expensive to present ads above search results, than to the right of them. Cost also may take into account other values, such as the relevance of the ad to the user, the title of the ad, the copy/abstract used in the ad, the Universal Resource Indicator (URI) linked to by the ad, etc. In any event, an expected utility function that takes into account both revenue and cost may deem the best slate to be the one which has the highest potential revenue and the lowest potential cost.

The value of an expected utility may also be a function of “unknown” variables, such as, for example, whether the user will actually click on an ad, whether there will be a post-click conversion, etc. As is known in the art, conversions are essentially user actions desired by advertisers after a user has clicked through to a site from an ad; such actions may include subsequent product sales, newsletter subscriptions, membership registrations, software downloads, etc. Obviously the probability of a click, conversion, etc., can themselves depend on several factors, including matching the right visitor with the right ad (i.e., the relevance of an ad to a particular user), the user's current interest level, the ease with which the desired action may be taken, etc.

In order to account for all of the different unknown variables, there may be a different utility function defined for each combination of unknown variables, which utility function assumes these variables are known (e.g., assuming it was known that a user clicked on a particular ad, etc.), as illustrated by Table 1 below.

TABLE 1

Unknown variables

| Click (1/0) | Conversion (1/0) | Utility Function |
|---|---|---|
| 1 | 1 | PPC − cost( . . . ) |
| 1 | 0 | (1 − D) * PPC − cost( . . . ) |
| 0 | — | −cost( . . . ) |

Showing no ads would mean no utility (i.e., no revenue, no cost).

As shown by the example in Table 1, a slate's utility may be determined by the actions taken with respect to that slate by a user. For example, consider the situation where a slate is presented to a user, the user actually clicks on an ad within the slate, and then the user takes some desired action at the landing page (i.e., there is a conversion); in such a case, and using the example shown in Table 1, the utility of the slate may be quantified as the clicked ad's price-per-click (PPC) value minus the cost of presenting the slate, where cost is defined by the system and based on various factors, as previously described. Similarly, where there is a click, but no conversion, the utility of the ad may be quantified as (1-D)*PPC—cost, where D is a discount factor. The discount may be applied as a fraction of the PPC, a fixed amount subtracted from the PPC, etc.

In light of these particular variables, an expected utility function may be defined, against which the various slates will be calculated. For example, an expected utility function, taking into account the information from Table 1, may take the following form:

$$\begin{matrix}Expected Utility = P ( click , conversion ) * ( PPC - cost ) + \\ P ( click , no\_conversion ) * [ ( 1 - D ) * PPC - cost ] - \\ P ( no\_click ) * cost\end{matrix} \qquad ( 1 )$$

It will be appreciated that Equation (1) is just one example of an expected utility function that takes into account the utility functions of Table 1, and that the variables of Table 1 can be removed and/or supplemented by various others and the equation shaped in any of a number of different ways so as to give any one element more weight than any other element, etc.

P in equation (1) stands for probability: whether a user will click on an ad, whether there will be a subsequent conversion, etc., cannot be known beforehand (i.e., before the ads are shown to the user), but the probability of any of those things happening can be determined to some extent (by, for example, standard machine learning or statistical methods such as logistic regression) and subsequently used to inform the expected utility function. For example, the probability that a user will click on an ad may be informed by several factors including the relevance of the ad to a particular user, where in a list of ads the particular ad is placed (i.e., its rank), whether the ad is placed above or to the side of the main content on the page, etc. Similarly, the probability that a click will turn into a conversion may turn on multiple factors. Using statistical models developed by the system over time, the probability that any of the unknown variables will result in a particular value (e.g., the probability that an ad will be clicked on) can be estimated, and this estimation can be built into the expected utility function, as is shown by equation (1).

In an embodiment, the values of the known (e.g., cost) and unknown (e.g., probability of a certain action) variables may be informed by user-specific characteristics. As an example, consider the determination of the probability that a user will click on an ad; such a determination may be informed by various user-specific characteristics, including the user's search history, (e.g., previous n queries, time stamps of the last n queries, etc.), information provided by a cookie residing on the user's system, geographic information (including, for example, the user's physical location and the current weather at that location, etc.), historical click-through rates, gender, languages spoken, marital status, number of children, income, time of day, time of year (i.e., season), etc. More specifically, and continuing with the example, the system may determine—using the user-specific characteristics available to it—that the probability that a particular user will click on an ad (or a particular ad, etc.) is greater between the hours of 9-11 PM than between the hours of 1-2 PM. The user-specific information may itself be informed by information known by the system about other users of the system who share with the particular user similar interests, backgrounds, recorded behavior, etc. It will be appreciated that the user-specific characteristics discussed above are only examples, and that various other characteristics and information will be apparent to those skilled in the art.

After the expected utility function has been defined, the system can run the function against slates corresponding to the particular query terms or the content on the web page where the ads are to be shown (e.g., where each slate to potentially be used comprises only ads that are relevant to a query, etc.), and then choose and present the slate with the maximum expected utility. It will be appreciated that various methods may be used to evaluate a subset of potential slates, rather than performing an exhaustive evaluation of every potential slate. It also will be appreciated that a slate's expected utility may be determined in a number of different ways. For example, it may be the sum of the expected utilities of each of its ads, the average or mean of the expected utilities of each of its ads, the expected utility of the entire slate (calculated after aggregate values are deduced for each of the known and unknown variables), etc.

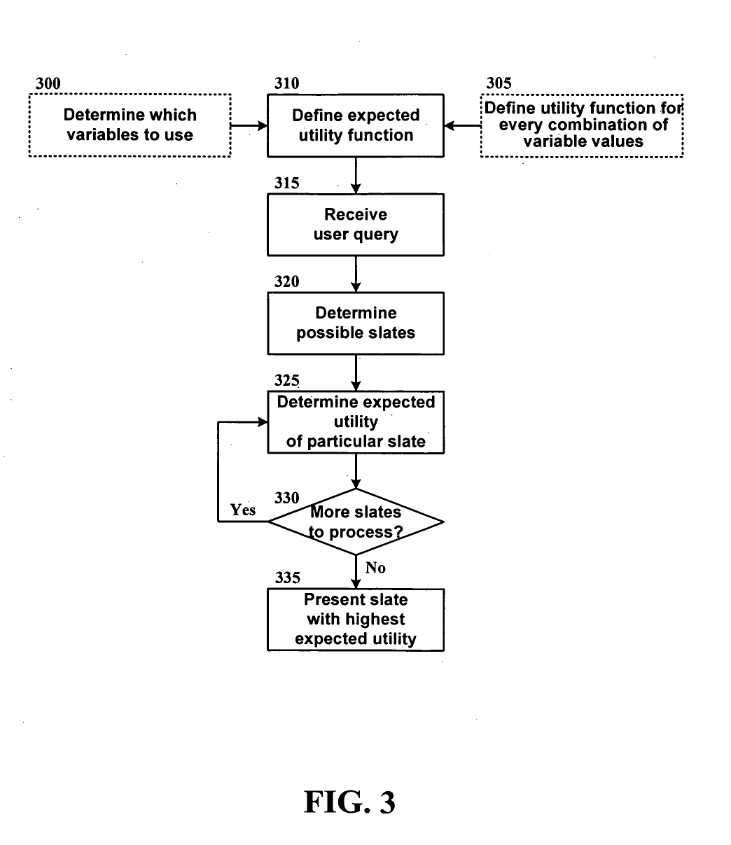

FIG. 3 is a logical flowchart of the general process by which a system may determine which slate to present to a user who has submitted a search query. It will be appreciated that while FIG. 3 outlines the general process regarding a search query and subsequent search results, a similar process may be used for the scenario where the ads are being shown on a non-search-results page, in which case the ads to be selected will be informed by at least the terms of the web page instead of at least the query terms used in the search.

Before an expected utility function can be defined at block 310, some threshold decisions must be made, as shown at blocks 300 and 305. First, it must be determined which unknown variables will be used to inform the utility function. After that determination, a utility function is defined for every combination of the selected variables, also taking into account the known variables (e.g., cost and revenue, as shown previously by the example in Table 1). It will be appreciated that the utility function for one combination of variables may be the same as the utility function for another combination—especially when there are numerous variables to be taken into account—and that these functions may be changed at any time depending on what utility metric the utility functions are ultimately meant to provide (e.g. revenue vs. cost, cost only, etc.). It will be appreciated that a utility value for the “null” state (i.e., when no ads are to be presented) can be defined (e.g., such a state may be ascribed zero utility); if no other state is found with a higher expected utility, then the null state would “win” and no ads would be presented to the user.

After the variables and the utility functions associated with their various combinations have been defined, an expected utility function may be defined which takes into account the various utility functions, as illustrated at block 310. The expected utility function seeks to determine the expected utility of each combination of the selected variables, based generally on the probability that various actions will be taken by the user (e.g., that the user will click on a particular ad, that a user will sign up to a service offered through a particular ad, etc.). As previously discussed, Equation (1) is an example of an expected utility function, which is based on the example variables and associated example utility functions shown in Table 1.

At block 315 a query is received from a user and the system determines a base set of advertisements that might be shown against the query; generally, the ads to be shown against the search are those that are at least somewhat relevant to the search query, the user, the user and query, etc. For example, it probably would not be useful to show an ad for diapers when the user has searched for information about cars, and so diaper ads may be filtered out of the set of ads to possibly be shown to the user (however, if such an ad was shown, it would likely be associated with a very high cost given its low relevancy). As discussed above, the relevance of particular ads to the user may be based on user-specific characteristics derived from information already known about the user, through, for example, the user's past use of the system. Once the ads have been decided, the system then determines the possible slates for those ads, as shown at block 320. The expected utility function defined at block 310 is then run against every slate to determine an expected utility of each slate, as illustrated by blocks 325 and 330. The expected utilities of each slate may be calculated in various ways.

For example, the expected utility function may be applied individually against each ad in the slate, in which case the expected utility of the slate may be the sum of the expected utilities of its constituent ads. In such a case, the costs and revenues associated with each individual ad (assuming those are the known variables used by the expected utility function) may or may not be predicated on the other ads in the slate. For example, an ad's individual cost may be a function of its position relative to the other ads (e.g., other things being equal, the last ad in a list of four ads would have a higher cost than the first ad in the list); or, cost may be based solely on the size of the ad, irrespective of where it appears on the page, or where it is with respect to the other ads in the slate.

As another example of how the expected utility of a slate may be calculated, the expected utility function may be taken across the entire slate at once, instead of calculating the expected utility of each ad in the slate and then summing them. In this case, the cost value used in the expected utility function shown in Equation (1) may be the aggregate cost associated with the screen real estate taken up by the current slate (with or without deference to other values that may inform the cost of each ad, such as, for example, relevance to the user). It will be appreciated that this value can be derived in any of a number of other different ways. Referring again to Equation (1) as an example, revenue of the slate may be determined as the average or total PPC of all the ads in the slate. It will be appreciated that this value can be derived in any of a number of other different ways. Similarly, the unknown variables may be derived. For example, going back to Table 1, the total probability that any ad will be clicked may be a function of the probabilities of each of the individual ads being clicked. Once the aggregate or total values of all the unknown and known variables used by the particular expected utility function have been determined, the expected utility function can then be run on the slate and an expected utility for the slate output.

To mitigate the cost or speed of operation or for other reasons, the system may make assumptions as to how the user may act. For example, the system may assume, based on past action, that if a user clicks on an ad in a slate, the user will not click on another ad in the same slate (e.g., the user will not hit the back button on her browser and click another ad, etc.). In such an instance, the probability that a user will click on any particular ad may become P(particular_ad)*[1-P(ad₁)]*[1-P(ad₂)]* . . . [1-P(adₙ)]. As another example, the system may assume that a user will not click on more than two ads an hour, and may adjust accordingly the cost of presenting ads to that user after two ads have been clicked on within any one-hour period (e.g., the system may remove the cost variable from the expected utility function, etc.).

No matter the decision as to how the expected utility of each slate is to be calculated, block 335 presents the slate with the highest expected utility after all of the generated slates have been processed.

The sequence and numbering of blocks depicted in FIG. 3 is not intended to imply an order of operations to the exclusion of other possibilities. Those of skill in the art will appreciate that the foregoing systems and methods are susceptible of various modifications and alterations.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of determining which of a plurality of slates to present on a web page, each slate comprising at least one of a plurality of advertisements from a set of available advertisements, said method comprising:
defining an expected utility function, wherein the expected utility function takes into account:
at least one of a plurality of known variables;
at least one of a plurality of unknown variables; and
at least one of a plurality of utility functions, each associated with the at least one unknown variable, or a combination of unknown variables if more than one is used;
generating at least one of the plurality of slates;
calculating, using the expected utility function, an expected utility of each of the generated slates; and
presenting the slate with the highest expected utility.

2. The method of claim 1 wherein the at least one of a plurality of unknown variables is selected from the group consisting of:
a probability that the at least one advertisement will be clicked; and
a probability that the click will be converted.

3. The method of claim 1 wherein the at least one of a plurality of known variables is selected from the group consisting of:
a price-per-click associated with the at least one advertisement; and
a cost associated with presenting the at least one advertisement.

4. The method of claim 1 wherein the set of available advertisements is based on at least a query submitted to a search engine.

5. The method of claim 1 wherein the set of available advertisements is based on at least the terms found in the web page.

6. The method of claim 1 wherein the expected utility function is informed by the at least one advertisement's relevance to a user.

7. The method of claim 1 wherein the expected utility function is informed by at least one of a plurality of user-specific characteristics.

8. The method of claim 7 wherein the at least one of a plurality of user-specific characteristics is selected from the group consisting of:
past search history;
time stamps of last n queries;
historical click-through rates;
gender;
income;
marital status;
number of children;
household income;
language;
geographic location;
time of day;
time of year; and
current weather at geographic location.

9. The method of claim 1 wherein said calculating is based on a sum of the expected utilities of each of the advertisements in the at least one slate.

10. The method of claim 1 wherein the expected utility function is informed by the at least one advertisement's position on the web page.

11. The method of claim 1 wherein the expected utility function is informed by a relationship between the plurality of advertisements in the at least one slate.

12. The method of claim 11 wherein the relationship is based on the relative ordering of the advertisements within the at least one slate.

13. The method of claim 11 wherein the relationship is based on the relative positions of the advertisements within the at least one slate.

14. A computer-readable medium encoded with a set of instructions which, when performed by a computer, perform a method of determining which of a plurality of slates to present on a web page, each slate comprising at least one of a plurality of advertisements from a set of available advertisements, said method comprising:
defining an expected utility function, wherein the expected utility function takes into account:
at least one of a plurality of known variables;
at least one of a plurality of unknown variables; and
at least one of a plurality of utility functions, each associated with the at least one unknown variable, or a combination of unknown variables if more than one is used;
generating at least one of the plurality of slates;
calculating, using the expected utility function, an expected utility of each of the generated slates; and
presenting the slate with the highest expected utility.

15. The computer-readable medium of claim 14 wherein the at least one of a plurality of unknown variables is selected from the group consisting of:
a probability that the at least one advertisement will be clicked; and
a probability that the click will be converted.

16. The computer-readable medium of claim 14 wherein the at least one of a plurality of known variables is selected from the group consisting of:
a price-per-click associated with the at least one advertisement; and
a cost associated with presenting the at least one advertisement.

17. The computer-readable medium of claim 14 wherein the set of available advertisements is based on at least a query submitted to a search engine.

18. The computer-readable medium of claim 14 wherein the set of available advertisements is based on at least the terms found in the web page.

19. The computer-readable medium of claim 14 wherein the expected utility function is informed by the at least one advertisement's relevance to a user.

20. The computer-readable medium of claim 14 wherein the expected utility function is informed by at least one of a plurality of user-specific characteristics.

21. The computer-readable medium of claim 20 wherein the at least one of a plurality of user-specific characteristics is selected from the group consisting of:
past search history;
time stamps of last n queries;
historical click-through rates;
gender;
income;
marital status;
number of children;
household income;
language;
geographic location;
time of day;
time of year; and
current weather at geographic location.

22. The computer-readable medium of claim 14 wherein said calculating is based on a sum of the expected utilities of each of the advertisements in the at least one slate.

23. The computer-readable medium of claim 14 wherein the expected utility function is informed by the at least one advertisement's position on the web page.

24. The computer-readable medium of claim 14 wherein the expected utility function is informed by a relationship between the plurality of advertisements in the at least one slate.

25. The computer-readable medium of claim 24 wherein the relationship is based on the relative ordering of the advertisements within the at least one slate.

26. The computer-readable medium of claim 24 wherein the relationship is based on the relative positions of the advertisements within the at least one slate.

27. A system, comprising:
an expected utility function definer to define an expected utility function, wherein the expected utility function takes into account:
at least one of a plurality of known variables;
at least one of a plurality of unknown variables; and
at least one of a plurality of utility functions, each associated with the at least one unknown variable, or a combination of unknown variables if more than one is used;
a slate generator to generate at least one of a plurality of slates, each slate comprising at least one of a plurality of advertisements from a set of available advertisements;
an expected utility calculator to calculate, using the expected utility function, an expected utility of each of the generated slates; and
a slate presenter to present the slate with the highest expected utility.
